(19) United States
(12) Patent Application Publication
(10) Pub. No.: US 2020/0123422 A1
(43) Pub. Date: Apr. 23, 2020

(54) Photocurable Adhesive Sheet, Image Display Device Constituent Laminate, Image Display Device Production Method and Method for Preventing Corrosion of Conductive Member

(71) Applicant: Mitsubishi Chemical Corporation, Tokyo (JP)

(72) Inventors: Shinya Fukuda, Tokyo (JP); Masaya Minemoto, Tokyo (JP); Makoto Inenaga, Tokyo (JP)

(73) Assignee: Mitsubishi Chemical Corporation, Tokyo (JP)

(21) Appl. No.: 16/719,455

(22) Filed: Dec. 18, 2019

Related U.S. Application Data
(63) Continuation of application No. PCT/JP2018/022589, filed on Jun. 13, 2018.

(30) Foreign Application Priority Data
Jun. 23, 2017 (JP) 2017-122867

(51) Int. Cl. C09J 7/38; C09J 133/10; C09J 7/28; B32B 37/12; H01B 5/14; H01B 1/02

(52) U.S. Cl. CPC C09J 7/385; C09J 133/10; C09J 7/28; B32B 2037/1253; H01B 5/14; H01B 1/02; C09J 2433/00; B32B 37/12

(57) ABSTRACT

Provided is an adhesive sheet having photocurability, in particular, a photocurable adhesive sheet capable of suppressing corrosion of a conductive member comprising a silver-containing metal material after being bonded to the conductive member and photocured. Provided is an adhesive sheet for a conductive member, comprising an adhesive agent layer containing a (meth)acrylic acid ester (co)polymer, a photoinitiator which generates radicals upon receiving light, and a metal corrosion inhibitor having an absorption coefficient at 365 nm of 20 mL/g·cm or less, wherein the (meth)acrylic acid ester (co)polymer is a (co)polymer containing no carboxyl group-containing monomers.

### TECHNICAL FIELD

The present invention relates to a photocurable adhesive sheet having photocurability, in particular, a photocurable adhesive sheet capable of suppressing corrosion of a conductive member comprising a silver-containing metal material after being bonded to the conductive member and photocured.

### BACKGROUND ART

An image display device such as a personal computer, a mobile terminal (PDA), a game machine, a television (TV), a car navigation system, a touch panel, or a pen tablet, for example, an image display device using a flat or curved image display panel such as a plasma display (PDP), a liquid crystal display (LCD), an organic EL display (OLED), an electrophoretic display (EPD), or an interferometric modulator display (IMOD) is integrated by bonding constituent members with an adhesive sheet or a liquid adhesive agent without providing a gap between the constituent members, in order to secure visibility and prevent damage.

For example, an image display device having a structure in which a touch panel is inserted between the viewing side of a liquid crystal module and a surface protective panel is integrated by placing a liquid adhesive agent or an adhesive sheet between the surface protective panel and the viewing side of the liquid crystal module, and bonding the touch panel and the other constituent member, for example, the touch panel and the liquid crystal module or the touch panel and the surface protective panel.

As a method for filling the gap between the image display device constituent members with an adhesive agent, Patent Document 1 discloses a method in which a liquid adhesive resin composition containing an ultraviolet-curable resin is filled in the gap and then cured by irradiating with ultraviolet rays.

Also, Patent Document 2 discloses a method for producing an image display device, which includes a step of curing an adhesive agent by irradiating an adhesive sheet with ultraviolet rays through an image display unit after bonding the adhesive sheet to the gap. The adhesive sheet used as described above is preferably used since even the very thin adhesive sheet is able to secure both evenness followability on a print step of an adherend or foreign objects present on the interface of the adherend, and foaming resistance reliability under a high temperature and high humidity environment. In recent years, with the thinning of image display devices, the adhesive agent is also required to be thinned, and adhesive sheets having photocurability are being widely used.

Further, Patent Documents 3 to 8 disclose an adhesive sheet formed of a composition containing an acrylic polymer and a metal corrosion inhibitor.

### CITATION LIST

### Patent Document

Patent Document 1: International Publication No. WO 2010/027041
Patent Document 2: Japanese Patent Laid-Open No. 2010-072481
Patent Document 3: Japanese Patent Laid-Open No. 2013-166846
Patent Document 4: Japanese Patent Laid-Open No. 2014-177611
Patent Document 5: Japanese Patent Laid-Open No. 2014-177612
Patent Document 6: Japanese Patent Laid-Open No. 2015-004048
Patent Document 7: Japanese Patent Laid-Open No. 2017-110062
Patent Document 8: Japanese Patent Laid-Open No. 2010-150396

### SUMMARY OF THE INVENTION

### Problem to be Solved by the Invention

The touch panel usually comprises an upper electrode plate and a lower electrode plate having a micro wiring and a transparent conductive layer formed of a metal material such as a tin-doped indium oxide (ITO).

In addition, a conductive pattern formed of a metal material is provided around the transparent conductive layer in order to collect and communicate position information of fingers or touch pens detected by the transparent conductive layer.

The transparent conductive layer and the conductive pattern are generally formed of a tin-doped indium oxide (ITO).

However, the ITO has a problem of having a high surface resistance and being fragile in bending. Therefore, with the recent increase in screen size, flexibility, and foldability of image display devices, a silver-containing metal material, which has a low surface resistance and is also strong in bending, is attracting attention as an alternative material for the ITO.

The thinning of the conductive pattern is also progressing in accordance with the narrowing of the frame of the image display device, and thus a conductive pattern formed of a silver-containing metal material is attracting attention.

However, there has been a problem that silver is inferior in corrosion resistance as compared to the ITO. Especially, when an image display device is produced by bonding a photocurable adhesive sheet to a conductive member comprising a silver-containing metal material, laminating two image display device-constituting members via the adhesive sheet, and curing the adhesive sheet by irradiating with light, there has been a problem that the corrosion on the silver-containing metal material is particularly progressed.

As a result of studying the corrosion of the metal material when the photocurable adhesive sheet is bonded to a conductive member comprising a silver-containing metal material and photocured, it has been found that the photoinitiator contained in the adhesive sheet is activated with light to generate radicals, and the radicals react with silver contained in the metal material, so that the corrosion of the silver-containing metal material is progressed.

Thus, the present invention is intended to provide a novel photocurable adhesive sheet capable of suppressing corrosion of a conductive member comprising especially a silver-containing metal material after being bonded to the conductive member and photocured.

### Means for Solving Problem

The present invention proposes a photocurable adhesive sheet that is used for being bonded to a conductive member comprising especially a silver-containing metal material, wherein the photocurable adhesive sheet has an adhesive agent layer containing a (meth)acrylic acid ester (co)polymer, a photoinitiator that generates radicals upon receiving light, and a metal corrosion inhibitor having an absorption coefficient at 365 nm of 20 mL/g·cm or less; and wherein the (meth)acrylic acid ester (co)polymer is a (co)polymer containing no carboxyl group-containing monomers.

### Effect of the Invention

When the photocurable adhesive sheet proposed by the present invention is cured by irradiating with light after the adhesive sheet is laminated on a conductive member comprising a silver-containing metal material, a protective film is formed on silver in the conductive member by a metal corrosion inhibitor contained in the adhesive sheet upon irradiating with light, and is able to suppress the reaction of radicals generated from a photoinitiator by the light irradiation with silver contained in the conductive member, so that corrosion of the conductive member can be suppressed.

Thus, the photocurable adhesive sheet proposed by the present invention can be used as an adhesive sheet suitable for being bonded to various kinds of conductive members such as a conductive member having a conductive pattern formed of a silver-containing metal material. In particular, the photocurable adhesive sheet can be suitably used as an adhesive sheet for an image display device having a touch panel.

### BRIEF DESCRIPTION OF DRAWINGS

FIG. 1 is a view for describing an evaluation test method of silver corrosion resistance reliability performed in Examples described below, in which (A) is a top view of a sample for silver corrosion resistance reliability evaluation, and (B) is a cross-sectional view of the sample for silver corrosion resistance reliability evaluation.

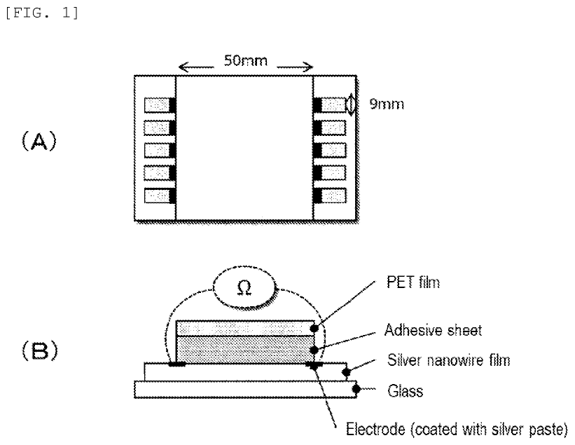

### MODE(S) FOR CARRYING OUT THE INVENTION

Hereinafter, an example of the embodiment of the present invention will be described in detail. However, the present invention is not limited to the following embodiment.

[Photocurable Adhesive Sheet]

The photocurable adhesive sheet according to an example of the embodiment of the present invention (hereinafter, also referred to as “present adhesive sheet”) has an adhesive agent layer composed of an adhesive agent composition (referred to as “present adhesive agent composition”) containing a (meth)acrylic acid ester (co)polymer, a photoinitiator that generates radicals upon receiving light, and a metal corrosion inhibitor having an absorption coefficient at 365 nm of 20 mL/g·cm or less.

Here, the “photocurable adhesive sheet” means an adhesive sheet having a property of being cured by irradiating with light.

Also, the “(co)polymer” means encompassing both a homopolymer and a copolymer; the “(meth)acrylate” means encompassing both acrylate and methacrylate; and the “(meth)acryloyl means encompassing both acryloyl and methacryloyl.

Further, the “light” specifically means light in a wavelength region of 200 to 780 nm; and the “photocurable” means having curability in such a wavelength region.

Since the adhesive sheet disclosed in each of Patent Documents 3 to 8 is cured using a photoinitiator at the time of production, the photoinitiator is deactivated. Thus, after the production, there is no photoinitiator that generates radicals upon receiving light in the adhesive agent layer constituting the adhesive sheet.

For this reason, the radicals cannot be generated after forming the adhesive sheet, and there is also no corrosion problem due to the radicals.

On the other hand, the present adhesive sheet is an adhesive sheet having a property of being cured by irradiating with light as described above, and unlike the adhesive sheets disclosed in Patent Documents 3 to 8, the present adhesive sheet is characterized in that a photoinitiator that generates radicals upon receiving light is present in the adhesive agent layer without being deactivated.

[Present Adhesive Agent Composition]

As described above, the present adhesive agent composition is a composition containing a (meth)acrylic acid ester (co)polymer, a photoinitiator that generates radicals upon receiving light, a metal corrosion inhibitor having an absorption coefficient at 365 nm of 20 mL/g·cm or less, and optionally a crosslinking agent.

<(Meth)Acrylic Acid Ester (Co)Polymer>

Examples of the (meth)acrylic acid ester (co)polymer may include an alkyl (meth)acrylatehomopolymer and a copolymer obtained by polymerizing a monomer component copolymerizable therewith.

More preferably, examples thereof may include a copolymer containing an alkyl (meth)acrylate homopolymer and any one or more monomers copolymerizable therewith selected from a hydroxyl group-containing monomer, an amino group-containing monomer, an epoxy group-containing monomer, an amide group-containing monomer, and any other vinyl monomer, as constituent units.

Among others, the (meth)acrylic acid ester (co)polymer in the present adhesive agent composition is preferably a (co)polymer containing no carboxyl group-containing monomers as constituent units for the purpose of suppressing corrosion of a metal member.

Here, the phrase “containing no carboxyl group-containing monomers as constituent units” means “not substantially containing” and the case of not containing at all, and is intended to encompass containing less than 0.5% by mass of a copolymerizable monomer A, preferably less than 0.1% by mass, in the (meth)acrylic acid ester (co)polymer.

The (meth)acrylic acid ester (co)polymer can be produced by using monomers exemplified below and optionally a polymerization initiator according to a conventional method.

More specific examples of the (meth)acrylic acid ester (co)polymer) may include a copolymer composed of a linear or branched alkyl (meth)acrylate having 4 to 18 carbon atoms in the side chain (hereinafter, also referred to as “copolymerizable monomer A”) and any one or more monomer components copolymerizable therewith selected from the following groups B to E.

Macromonomer (hereinafter, also referred to as “copolymerizable monomer B”)

(Meth)acrylate having 1 to 3 carbon atoms in the side chain (hereinafter, also referred to as “copolymerizable monomer C”)

Hydroxyl group-containing monomer (hereinafter, also referred to as “copolymerizable monomer D”)

Other vinyl monomer (hereinafter, also referred to as “copolymerizable monomer E”)

Also, particularly preferable examples of the (meth)acrylic acid ester (co)polymer may include (a) a copolymer composed of a monomer component containing a copolymerizable monomer A and a copolymerizable monomer B, and (b) a copolymer composed of a monomer component containing a copolymerizable monomer A, a copolymerizable monomer B and/or a copolymerizable monomer C, and a copolymerizable monomer D and/or a copolymerizable monomer E.

(Copolymerizable Monomer A)

Examples of the linear or branched alkyl (meth)acrylate having 4 to 18 carbon atoms in the side chain (copolymerizable monomer A) may include n-butyl (meth)acrylate, isobutyl (meth)acrylate, sec-butyl (meth)acrylate, t-butyl (meth)acrylate, pentyl (meth) acrylate, isopentyl (meth) acrylate, neopentyl (meth)acrylate, hexyl (meth)acrylate, cyclohexyl (meth) acrylate, heptyl (meth) acrylate, 2-ethylhexyl (meth)acrylate, n-octyl (meth)acrylate, isooctyl (meth)acrylate, nonyl (meth)acrylate, isononyl (meth) acrylate, t-butylcyclohexyl (meth) acrylate, decyl (meth)acrylate, isodecyl (meth)acrylate, undecyl (meth)acrylate, lauryl (meth)acrylate, tridecyl (meth)acrylate, tetradecyl (meth)acrylate, cetyl (meth)acrylate, stearyl (meth)acrylate, isostearyl (meth)acrylate, behenyl (meth)acrylate, isobornyl (meth)acrylate, 3,5,5-trimethylcyclohexane (meth)acrylate, dicyclopentanyl (meth) acrylate, dicyclopentenyl (meth) acrylate, dicyclopentenyloxyethyl (meth) acrylate, and benzyl (meth)acrylate. These may be used singly or in combination of two or more kinds thereof.

The copolymerizable monomer A is preferably contained in an amount of 30% by mass or more and 90% by mass or less, more preferably 35% by mass or more or 88% by mass or less, even more preferably 40% by mass or more or 85% by mass or less, in the total monomer components of the copolymer.

(Copolymerizable Monomer B)

The macromonomer (copolymerizable monomer B) is a monomer that provides 20 or more carbon atoms in the side chain when forming a (meth)acrylic acid ester (co)polymer through polymerization. The use of the copolymerizable monomer B can provide a graft copolymer as the (meth)acrylic acid ester (co)polymer.

Accordingly, the characteristics of the main chain and the side chain of the graft copolymer can be changed by the selection and the blending ratio of the copolymerizable monomer B and the other monomers.

The macromonomer (copolymerizable monomer B) preferably has a framework component that is constituted by an acrylic acid ester copolymer or a vinyl-based polymer.

Examples of the framework component of the macromonomer may include components exemplified for the aforementioned copolymerizable monomer A, and the copolymerizable monomers C and D described below; and these can be used singly or in combinations of two or more kinds thereof.

The macromonomer has a radical polymerizable group or a functional group such as a hydroxyl group, an isocyanate group, an epoxy group, a carboxyl group, an amino group, an amide group, and a thiol group.

The macromonomer preferably has a radical polymerizable group capable of being copolymerized with the other monomers. One or two or more radical polymerizable groups may be contained, and a compound containing one radical polymerizable group is particularly preferred. Also, in the case where the macromonomer contains a functional group, one or two or more functional groups may be contained, and a compound containing one functional group is particularly preferred. In addition, the macromonomer may contain either one of the radical polymerizable group and the functional group, or may contain both of them.

The copolymerizable monomer B preferably has a number average molecular weight of 500 to 20,000, more preferably 800 or more or 8,000 or less, even more preferably 1,000 or more or 7,000 or less.

As the macromonomer, a generally produced one (for example, a macromonomer manufactured by Toagosei Co., Ltd.) can be appropriately used.

The copolymerizable monomer B is preferably contained in an amount of 5% by mass or more and 30% by mass or less, more preferably 6% by mass or more or 25% by mass or less, even more preferably 8% by mass or more or 20% by mass or less, in the total monomer components of the copolymer.

(Copolymerizable Monomer C)

Examples of the (meth)acrylate having 1 to 3 carbon atoms in the side chain (copolymerizable monomer C) may include methyl (meth)acrylate, ethyl (meth)acrylate, n-propyl (meth)acrylate, and i-propyl (meth)acrylate. These may be used singly or in combination of two or more kinds thereof.

The copolymerizable monomer C is preferably contained in an amount of 0% by mass or more and 70% by mass or less, more preferably 3% by mass or more or 65% by mass or less, even more preferably 5% by mass or more or 60% by mass or less, in the total monomer components of the copolymer.

(Copolymerizable Monomer D)

Examples of the hydroxyl group-containing monomer (copolymerizable monomer D) may include hydroxyalkyl (meth)acrylates such as 2-hydroxyethyl (meth)acrylate, 2-hydroxypropyl (meth) acrylate, 3-hydroxypropyl (meth)acrylate, and 2-hydroxybutyl (meth)acrylate. These may be used singly or in combination of two or more kinds thereof.

The copolymerizable monomer D is preferably contained in an amount of 0% by mass or more and 30% by mass or less, more preferably 0% by mass or more or 25% by mass or less, even more preferably 0% by mass or more or 20% by mass or less, in the total monomer components of the copolymer.

(Copolymerizable Monomer E)

Examples of the other vinyl monomer (copolymerizable monomer E) may include compounds having a vinyl group in the molecule, excluding the copolymerizable monomers A to D. Examples of such compounds may include functional monomers having functional group such as an amide group and an alkoxyalkyl group in the molecule; polyalkylene glycol di(meth)acrylates; vinyl ester monomers such as vinyl acetate, vinyl propionate, and vinyl laurate; and aromatic vinyl monomers such as styrene, chlorostyrene, chloromethylstyrene, α-methylstyrene, and other substituted styrenes. These may be used singly or in combination of two or more kinds thereof.

The copolymerizable monomer E is preferably contained in an amount of 0% by mass or more and 30% by mass or less, more preferably 0% by mass or more or 25% by mass or less, even more preferably 0% by mass or more or 20% by mass or less, in the total monomer components of the copolymer.

In addition to those described above, epoxy group-containing monomers such as glycidyl (meth)acrylate, glycidyl α-ethylacrylate, and 3,4-epoxybutyl (meth)acrylate; amino group-containing (meth)acrylic acid ester monomers such as dimethylaminoethyl (meth)acrylate and diethylaminoethyl (meth)acrylate; monomers containing an amide group or an imide group such as (meth)acrylamide, N-t-butyl (meth)acrylamide, N-methylol (meth)acrylamide, N-methoxymethyl (meth) acrylamide, N-butoxymethyl (meth)acrylamide, diacetone (meth)acrylamide, and maleimide; and heterocyclic basic monomers such as vinylpyrrolidone, vinylpyridine, and vinylcarbazole, can be appropriately used as necessary.

Among others, the (meth)acrylic acid ester (co)polymer preferably has a chemical bond by any combination of functional groups selected from an amide group and a carboxyl group, and a hydroxyl group and an isocyanate group, or has a graft copolymer comprising a macromonomer as a branch component.

Also, the (meth)acrylic acid ester (co)polymer is preferably a copolymer composed of monomer components containing a linear or branched alkyl (meth)acrylate having 4 to 18 carbon atoms in the side chain and a hydrophilic (meth)acrylate having no carboxyl group, selected from the copolymerizable monomers described above, as a monomer copolymerizable therewith.

The hydrophilic (meth)acrylate is preferably a methyl acrylate or an ester having a polar group, and the polar group is preferably a (meth)acrylate having a polar group other than a carboxyl group. Among others, hydroxyl group-containing (meth)acrylates such as hydroxyethyl (meth) acrylate, hydroxypropyl (meth) acrylate, hydroxybutyl (meth)acrylate, and glycerol (meth)acrylate; and amide group-containing (meth)acrylates such as N,N-dimethylacrylamide and hydroxyethylacrylamide, are preferred. These may be used singly or in combination of two or more kinds thereof.

((Meth)Acrylic Acid Ester (Co)Polymer)

Most typical examples of the (meth)acrylic acid ester (co)polymer may include a (meth)acrylic acid ester copolymer obtained by copolymerizing monomer components containing (a) any one or more monomer components selected from the group consisting of 2-ethylhexyl (meth)acrylate, octyl (meth)acrylate, decyl (meth)acrylate, isostearyl (meth)acrylate, lauryl (meth)acrylate, tridecyl (meth)acrylate, butyl (meth)acrylate, ethyl (meth)acrylate, and methyl (meth)acrylate; and (b) any one or more monomer components having an organic functional group, selected from the group consisting of hydroxyethyl (meth)acrylate, hydroxypropyl (meth) acrylate, hydroxybutyl (meth) acrylate, glycerol (meth)acrylate, vinyl acetate, glycidyl (meth)acrylate, (meth)acrylamide, (meth)acrylonitrile, fluorinated (meth)acrylate, and silicone (meth)acrylate.

The (meth)acrylic acid ester (co)polymer preferably has a mass average molecular weight of 100,000 or more and 1,500,000 or less, more preferably 150,000 or more or 1,300,000 or less, even more preferably 200,000 or more or 1,200,000 or less.

When it is desired to obtain an adhesive composition having high cohesive force, the mass average molecular weight of the (meth)acrylic acid ester (co)polymer is preferably 700,000 or more and 1,500,000 or less, particularly preferably 800,000 or more or 1,300,000 or less, from the viewpoint of obtaining cohesive force by entanglement of molecular chains as the molecular weight increases.

On the other hand, when it is desired to obtain an adhesive composition having high fluidity and stress relaxation properties, the mass average molecular weight thereof is preferably 100,000 or more and 700,000 or less, particularly preferably 150,000 or more or 600,000 or less.

Meanwhile, when a solvent is not used in forming an adhesive sheet or the like, the mass average molecular weight of the (meth)acrylic acid ester (co)polymer is preferably 100,000 or more and 700,000 or less, even more preferably 150,000 or more or 600,000 or less, particularly preferably 200,000 or more or 500,000 or less, since it is difficult to use a polymer having a large molecular weight.

<Photoinitiator>

The present adhesive agent composition preferably contains a photoinitiator that generates radicals upon receiving light. When an organic crosslinking agent having a (meth)acryloyl group is used as a crosslinking agent, it is particularly preferable to further add a photoinitiator. This is because the radicals are generated by light irradiation to serve as a starting point of a polymerization reaction in the system.

Since the present adhesive sheet is able to suppress a reaction between the radicals generated from a photoinitiator by light irradiation and silver in a conductive member, the present adhesive agent composition preferably contains a photoinitiator that generates the radicals upon receiving light.

The photoinitiator is roughly classified into two types in terms of the radical generation mechanism, and is broadly divided into a cleavage-type photoinitiator capable of generating radicals by cleaving and decomposing a single bond of the photoinitiator itself and a hydrogen abstraction-type photoinitiator capable of forming an excited complex by the photoexcited initiator and a hydrogen donor in the system, and transferring hydrogen in the hydrogen donor.

A currently well-known initiator can be suitably used as the photoinitiator. Among others, a photoinitiator that is sensitive to ultraviolet rays having a wavelength of 380 nm or less is preferable from the viewpoint of easiness in controlling the reaction of the curing (crosslinking).

On the other hand, a photoinitiator that is sensitive to light having a wavelength longer than 380 nm is preferable since high photoreactivity can be obtained and the sensitive light can readily reach the deep part of the present adhesive sheet.

Of these, the cleavage-type photoinitiator becomes other compounds through decomposition at the time of generating radicals by light irradiation, and loses the function as an initiator after the photoinitiator is once excited. Therefore, the cleavage-type photoinitiator is preferable since the cleavage-type photoinitiator does not remain in the adhesive agent as an active species after completing the curing (crosslinking) reaction, and thereafter the radicals are not generated again when the adhesive agent is exposed to light.

Meanwhile, the hydrogen abstraction-type initiator is useful since the hydrogen abstraction-type initiator does not generate a decomposition product, as in the case of the cleavage-type initiator, at the time of the reaction of radicals generated by irradiation with active energy rays such as ultraviolet rays, and thus it can be hardly converted into a volatile component after completing the reaction, resulting in decrease of damage to the adherend.

As the cleavage-type photoinitiator, an acylphosphine oxide-based photoinitiator, such as bis (2,4,6-trimethylbenzoyl)-phenylphosphine oxide, 2,4,6-trimethylbenzoyldiphenylphosphine oxide, (2,4,6-trimethylbenzoyl) ethoxy phenylphosphine oxide, or bis (2,6-dimethoxybenzoyl) 2,4,4-trimethylpentylphosphine oxide, is preferable since the photoinitiator has high sensitivity to light and is decolored in the form of the decomposition product after the reaction.

Examples of the hydrogen abstraction-type photoinitiator may include benzophenone, 4-methylbenzophenone, 2,4,6-trimethylbenzophenone, 4-phenylbenzophenone, 3,3′-dimethyl-4-methoxybenzophenone, 4-(meth)acryloyloxybenzophenone, 4-[2-((meth)acryloyloxy)ethoxy]benzophenone, 4-(meth) acryloyloxy-4′-methoxybenzophenone, methyl 2-benzoylbenzoate, methyl benzoylformate, bis(2-phenyl-2-oxoacetic acid)oxybisethylene, 4-(1,3-acryloyl-1,4,7,10,13-pentaoxotridecyl)benzophenone, thioxanthone, 2-chlorothioxanthone, 3-methylthioxanthone, 2,4-dimethylthioxanthone, anthraquinone, 2-methylanthraquinone, 2-ethylanthraquinone, 2-tert-butylanthraquinone, 2-aminoanthraquinone, camphorquinone, and any derivatives thereof.

Among them, benzophenone, 4-methylbenzophenone, 2,4,6-trimethylbenzophenone, 4-phenylbenzophenone, 3,3′-dimethyl-4-methoxybenzophenone, 4-(meth)acryloyloxybenzophenone, 4-[2-((meth)acryloyloxy)ethoxy]benzophenone, 4-(meth)acryloyloxy-4′-methoxybenzophenone, methyl 2-benzoylbenzoate, methyl benzoylformate are preferred.

Here, one kind of the aforementioned photoinitiators or a derivative thereof may be used, and two or more kinds thereof may be used in combination.

Further, a sensitizer may also be used in addition to the photoinitiator. The sensitizer is not particularly limited, and any sensitizer that is used for a photoinitiator can be properly used. Examples thereof may include aromatic amines, an anthracene derivative, an anthraquinone derivative, a coumarin derivative, a thioxanthone derivative, a phthalocyanine derivative, aromatic ketones such as benzophenone, xanthone, thioxanthone, Michler's ketone, and 9,10-phenanthraquinone, and any derivatives thereof.

Here, the photoinitiator and the sensitizer may be contained in a state of being bonded to the (meth)acrylic acid ester (co)polymer. As the method for bonding the photoinitiator and the sensitizer to the (meth)acrylic acid ester (co)polymer, a method similar to the case where the crosslinking agent is bonded to the (meth)acrylic acid ester (co)polymer as described below can be employed.

The content of the photoinitiator is not particularly limited. Typically, the content thereof is preferably adjusted at a ratio of 0.1 part by mass or more and 10 parts by mass or less, more preferably 0.2 part by mass or more or 5 parts by mass or less, even more preferably 0.5 part by mass or more or 3 parts by mass or less, relative to 100 parts by mass of the (meth)acrylic acid ester (co)polymer. However, in view of the balance with other elements, it may be more than this range.

<Metal Corrosion Inhibitor>

The metal corrosion inhibitor contained in the present adhesive agent composition preferably has an absorption coefficient at 365 nm of 20 mL/g·cm or less, more preferably 10 mL/g·cm or less, even more preferably 5 mL/g·cm or less, particularly preferably 1 mL/g·cm or less, from the viewpoint of not inhibiting the photoreaction of the present adhesive agent composition by the contained metal corrosion inhibitor.

As the metal corrosion inhibitor having such characteristics, a metal corrosion inhibitor not having any framework selected from a naphthalene framework, an anthracene framework, a thiazole framework, and a thiadiazole framework, is preferred. When the metal corrosion inhibitor does not have such a framework, the absorption coefficient in the above range can be provided.

Also, the metal corrosion inhibitor contained in the present adhesive agent composition is preferably a hydrophilic compound. When the metal corrosion inhibitor is hydrophilic, it can readily move around in the adhesive agent layer containing the (meth)acrylic acid ester (co)polymer, which is also hydrophilic, as a base resin. Therefore, the metal corrosion inhibitor can be chemically bonded to, for example, silver atoms to form a protective film, and the attack (reaction) to the radical metal member generated from the photoinitiator by irradiating with light, especially to silver, can be suppressed.

From such a viewpoint, the metal corrosion inhibitor preferably has an aqueous solubility at 25° C. of 20 g/L or more, more preferably 50 g/L or more, particularly preferably 100 g/L or more.

Among metal corrosion inhibitors having an absorption coefficient at 365 nm of 20 mL/g·cm or less and comprising a hydrophilic compound, the metal corrosion inhibitor contained in the present adhesive agent composition is preferably a triazole-based compound. Among others, one or a mixture of two or more selected from benzotriazole, 1,2,3-triazole, and 1,2,4-triazole is particularly preferred.

Also, the benzotriazole may be any substituted or unsubstituted benzotriazole, and examples thereof may include alkylbenzotriazoles such as 1,2,3-benzotriazole and methyl-1H-benzotriazole; halogenobenzotriazoles such as carboxybenzotriazole, 1-hydroxybenzotriazole, 5-aminobenzotriazole, 5-phenylthiolbenzotriazole, 5-methoxybenzotriazole, nitrobenzotriazole, chlorobenzotriazole, bromobenzotriazole, and fluorobenzotriazole; copper benzotriazole, silver benzotriazole, and benzotriazole silane compounds. Among others, from the viewpoint of dispersibility and ease of addition to the adhesive agent composition, and metal corrosion prevention effect, any one or a mixture of two or more selected from the group consisting of 1,2,3-benzotriazole, 1-[N,N-bis(2-ethylhexyl)aminomethyl]benzotriazole, 1-[N,N-bis(2-ethylhexyl)aminomethyl]methylbenzotriazole, and 2,2′-[[(methyl-1H-benzotriazole-1-yl)methyl]imino]bisethanol, is preferred.

Further, 1,2,4-triazole is a solid having a melting point of about 120° C., and 1,2,3-triazole has a melting point of about 20° C. and is in a substantially liquid state at room temperature. Therefore, 1,2,3-triazole is excellent in dispersibility when mixed in the adhesive agent composition, can be uniformly mixed, and has excellent advantages such as easy master batch formation.

Here, the absorption coefficient at a wavelength of 365 nm can be determined by placing a solution diluted with a solvent (acetonitrile, acetone, and the like) that does not absorb light of the measurement wavelength into a quartz cell and measuring the absorbance of the solution.

The absorption coefficient can be determined by the following formula.

α₃₆₅=A₃₆₅×d/C

α₃₆₅: absorption coefficient at a wavelength of 365 nm [mL/(g·cm)]

A₃₆₅: absorbance at a wavelength of 365 nm

c: solution concentration [g/mL]

d: optical path length (of quartz cell) [cm]

In addition, when calculating the absorption coefficient, an absorbance converted from the measurement result of the transmittance may also be used.

A₃₆₅=−Log(T₃₆₅/100)

T₃₆₅: light transmittance at a wavelength of 365 nm [%]

From the viewpoint of effectively suppressing the attack (reaction) of the radicals generated from a photoinitiator by light irradiation, the metal corrosion inhibitor contained in the present adhesive agent composition is preferably contained at a ratio of 10 to 200 parts by mass, more preferably 20 parts by mass or more or 100 parts by mass or less, even more preferably 25 parts by mass or more or 80 parts by mass or less, relative to 100 parts by mass of the photoinitiator.

Also, in the present adhesive agent composition, from the viewpoint of bleeding out of the metal corrosion inhibitor and the effect of preventing metal corrosion, the metal corrosion inhibitor is preferably contained at a ratio of 0.01 part by mass or more and 5 parts by mass or less, more preferably 0.1 part by mass or more or 1 part by mass or less, and even more preferably 0.2 part by mass or more or 0.5 part by mass or less, relative to 100 parts by mass of the (meth)acrylic acid ester (co)polymer.

(Crosslinking Agent)

The present adhesive agent composition may contain a crosslinking agent when necessary.

Examples of the method for crosslinking the (meth)acrylic acid ester (co)polymer may include a method in which a crosslinking agent capable of chemically bonding to a reactive group such as a hydroxyl group or a carboxyl group introduced into the (meth)acrylic acid ester (co)polymer is added and reacted by heating or curing; and a method in which a polyfunctional (meth)acrylate having two or more (meth)acryloyl groups as crosslinking agents and a reaction initiator such as a photoinitiator are added and crosslinked by irradiating with ultraviolet rays or the like. Of these, from the viewpoint of not consuming polar functional groups such as carboxyl groups in the present adhesive agent composition by reaction, and capable of maintaining a high cohesive force and adhesive properties derived from polar components, a crosslinking method by irradiating with ultraviolet rays or the like is preferred.

Examples of the crosslinking agent may include a crosslinking agent having at least one crosslinkable functional group selected from a (meth)acryloyl group, an epoxy group, an isocyanate group, a carboxyl group, a hydroxyl group, a carbodiimide group, an oxazoline group, an aziridine group, a vinyl group, an amino group, an imino group, an amide group, N-substituted (meth)acrylamide group, and an alkoxysilyl group; and these may be used singly or in combination of two or more kinds thereof.

Here, the crosslinkable functional group may be protected by a protective group capable of being deprotected.

Among others, polyfunctional (meth)acrylate is preferable from the viewpoint of ease of controlling the crosslinking reaction.

Examples of the polyfunctional (meth)acrylate may include ultraviolet-curable polyfunctional monomers such as 1,4-butanediol di(meth)acrylate, 1,6-hexanediol di(meth)acrylate, 1,9-nonanediol di(meth)acrylate, polyalkylene glycol di(meth)acrylate, neopentyl glycol di(meth)acrylate, glycerin di(meth)acrylate, pentaerythritol tri(meth)acrylate, pentaerythritol tetra(meth)acrylate, dipentaerythritol hexa(meth)acrylate, tripentaerythritol penta(meth)acrylate, trimethylolpropane tri(meth)acrylate, and tris(acryloxyethyl)isocyanurate; polyfunctional acrylic oligomers such as polyester (meth)acrylate, epoxy (meth)acrylate, urethane (meth)acrylate, and polyether (meth)acrylate; and polyfunctional acrylamide.

Examples of the crosslinking agent having two or more crosslinkable functional groups may include epoxy group-containing monomers such as glycidyl (meth)acrylate, glycidyl α-ethyl acrylate, 3,4-epoxybutyl (meth)acrylate, and 4-hydroxybutyl (meth)acrylate glycidyl ether; monomers containing an isocyanate group or a blocked isocyanate group such as 2-isocyanatoethyl (meth)acrylate, 2-(2-(meth)acryloyloxyethyloxy) ethyl isocyanate, 2-(0-[1′-methylpropylideneamino] carboxyamino) ethyl (meth) acrylate, and 2-[(3,5-dimethylpyrazolyl) carbonylamino] ethyl (meth)acrylate; and various silane coupling agents such as vinyltrimethoxysilane, vinyltriethoxysilane, 3-glycidoxypropyltrimethoxysilane, 3-(meth)acryloxypropylmethyldiethoxysilane, 3-(meth)acryloxypropyltriethoxysilane, N-2-(aminoethyl)-3-aminopropylmethyldimethoxysilane, and 3-isocyanatopropyltriethoxysilane.

The crosslinking agent having two or more crosslinkable functional groups may have a structure in which one of the functional groups is reacted with a (meth)acrylic acid ester (co)polymer and bonded to the (meth)acrylic acid ester (co)polymer. With such a structure, a double-bondable crosslinkable functional group such as a (meth)acryloyl group or a vinyl group can be chemically bonded to the (meth)acrylic acid ester (co)polymer.

Also, when the crosslinking agent is bonded to the (meth)acrylic acid ester (co)polymer, there is a tendency that bleeding out of the crosslinking agent and unexpected plasticizing of the present adhesive sheet can be suppressed.

In addition, when the crosslinking agent is bonded to the (meth)acrylic acid ester (co)polymer, the reaction efficiency of the photocrosslinking reaction is promoted, so that a cured product having higher cohesive force tends to be obtained.

The present adhesive agent composition may further contain a monofunctional monomer that reacts with a crosslinkable functional group of the crosslinking agent. Examples of the monofunctional monomer may include alkyl (meth)acrylates such as methyl acrylate; hydroxyl group-containing (meth)acrylates such as hydroxyethyl (meth) acrylate, hydroxypropyl (meth) acrylate, hydroxybutyl (meth)acrylate, and polyalkylene glycol (meth)acrylate; ether group-containing (meth)acrylates such as tetrahydrofurfuryl (meth)acrylate and methoxypolyethylene glycol (meth)acrylate; and (meth)acrylamide-based monomers such as (meth)acrylamide, dimethyl (meth)acrylamide, diethyl (meth) acrylamide, (meth) acryloylmorpholine, isopropyl (meth) acrylamide, dimethylaminopropyl (meth) acrylamide, phenyl (meth) acrylamide, N-methoxymethyl (meth) acrylamide, and N-butoxymethyl (meth) acrylamide.

Among others, from the viewpoint of improving the adhesion to an adherend and the effect of suppressing hygrothermal whitening, it is preferable to use a hydroxyl group-containing (meth)acrylate or a (meth)acrylamide monomer.

The content of the crosslinking agent is, from the viewpoint of balancing the flexibility and cohesive force of the present adhesive agent composition, preferably contained at a ratio of 0.01 part by mass or more and 10 parts by mass or less, more preferably 0.05 part by mass or more or 8 parts by mass or less, even more preferably 0.1 part by mass or more or 5 parts by mass or less, relative to 100 parts by mass of the (meth)acrylic acid ester (co)polymer.

When the present adhesive sheet is a multilayer, the content of the crosslinking agent in the intermediate layer or the layer serving as a substrate among the layers constituting the adhesive sheet may be more than the above range. The content of the crosslinking agent in the intermediate layer or the layer serving as a substrate is preferably blended at a ratio of 0.01 part by mass or more and 40 parts by mass or less, more preferably 1 part by mass or more or 30 parts by mass or less, even more preferably 2 parts by mass or more or 25 parts by mass or less, relative to 100 parts by mass of the (meth)acrylic acid ester (co)polymer.

<Other Components>

The present adhesive agent composition may contain other components when necessary, in addition to the (meth)acrylic acid ester (co)polymer, the photoinitiator, the metal corrosion inhibitor, and the crosslinking agent.

Examples of the other components may include various additives such as a crosslinking agent, a light stabilizer, an ultraviolet absorber, a metal deactivator, a metal corrosion inhibitor (excluding the above metal corrosion inhibitor), an anti-aging agent, an antistatic agent, a moisture absorbent, a foaming agent, a defoaming agent, inorganic particles, a viscosity modifier, a tackifying resin, a photosensitizer, and a fluorescent agent; and reaction catalysts (tertiary amine-based compounds, quaternary ammonium-based compounds, tin laurate compounds, and the like). In addition, the present adhesive agent composition may appropriately contain known components that are blended into an ordinary adhesive agent composition.

<Preparation of Present Adhesive Agent Composition>

The present adhesive agent composition can be obtained by mixing the (meth)acrylic acid ester (co)polymer, the photoinitiator, the metal corrosion inhibitor, optionally the crosslinking agent, and optionally other components in predetermined amounts.

The mixing method is not particularly limited, and the order of mixing the components is also not particularly limited.

In addition, a heat treatment step may be included in the production of the present adhesive agent composition, and in this case, it is preferable that the heat treatment is performed after mixing the components of the present adhesive agent composition. A master batch obtained by concentrating various mixed components may be used.

The apparatus for mixing is also not particularly limited, and, for example, a universal kneader, a planetary mixer, a banbury mixer, a kneader, a gate mixer, a pressure kneader, a thiple roll mixer, and a twin roll mixer can be used. A solvent may be used for mixing when necessary. Also, the present adhesive agent composition can be used as a solventless system containing no solvent. The use of the solventless system may prevent any solvent from remaining, so as to provide advantages including the enhancement of the heat resistance and the light resistance.

<Layer Structure and Thickness of Present Adhesive Sheet>

The present adhesive sheet is a photocurable adhesive sheet having an adhesive agent layer composed of the present adhesive agent composition.

Such an adhesive agent layer may be a single layer or a multilayer, and in the case of a multilayer, other layers such as a so-called substrate layer may be interposed. When the adhesive agent layer has a multilayer structure having other layers, the surface layer of the present adhesive sheet is preferably an adhesive agent layer composed of the adhesive agent composition.

When the present adhesive sheet is a multilayer, the thickness of the adhesive agent layer composed of the adhesive agent composition is not limited, and is preferably 10% or more, more preferably 30% or more, even more preferably 50% or more, relative to the total thickness of the present adhesive sheet. It is preferable when the thickness of the adhesive agent layer composed of the adhesive agent composition falls within the above range since corrosion resistance reliability, foaming resistance reliability, and the curing properties with respect to the conductive member are improved.

The thickness of the present adhesive sheet is preferably 10 μm or more and 500 μm or less, more preferably 15 μm or more or 400 μm or less, even more preferably 20 μm or more or 350 μm or less.

<Physical Properties of Present Adhesive Sheet>

The present adhesive sheet is preferably optically transparent. In other words, it is preferably a transparent adhesive sheet. Here, the “optically transparent” means that the total light transmittance is 80% or more, and is preferably 85% or more, more preferably 90% or more.

Since the present adhesive sheet has an adhesive agent layer containing a photoinitiator that generates radicals upon receiving light, the present adhesive sheet has a property that the adhesive agent layer is cured by irradiating with light after being bonded to the adherend.

Thus, the present adhesive sheet is in a state in which the photoinitiator in the adhesive agent layer has activity even after the production. As a preferred method for forming such an adhesive agent layer, the following method (1) or (2) can be cited.

(1) In the production of the present adhesive sheet, photocurability (photoactivity) is provided while maintaining the sheet shape in a temporarily-cured (primary crosslinked) state.

(2) In the production of the present adhesive sheet, photocurability (photoactivity) is provided while maintaining the sheet shape in an uncured (uncrosslinked) state.

Specific examples of the method (1) may include a method in which a composition (adhesive agent) containing a photopolymerization initiator, a (meth)acrylic acid ester (co)polymer having a functional group (i), a compound having a functional group (ii) that reacts with the functional group (i), and optionally a polyfunctional (meth)acrylate having two or more (meth)acryloyl groups, is heated or cured to form an adhesive agent layer.

According to the method, the functional group (i) in the (meth)acrylic acid ester (co)polymer and the functional group (ii) in the compound are reacted, and cured (crosslinked) by forming a chemical bond, thereby forming an adhesive agent layer. By forming the adhesive agent layer in this manner, the photopolymerization initiator can be present in the adhesive agent layer while having activity.

Here, as the photopolymerization initiator, any of the aforementioned cleavage-type photoinitiator and the hydrogen abstraction-type photoinitiator may be used.

Preferred examples of the combination of the functional group (i) and the functional group (ii) may include a combination of an amide group (functional group (i)) and a carboxyl group (functional group (ii)); and a combination of a hydroxyl group (functional group (i)) and an isocyanate group (functional group (ii)).

More specifically, the case where the (meth)acrylic acid ester copolymer has a hydroxyl group; the (meth)acrylic acid ester copolymer as a copolymer of a monomer component containing, for example, the hydroxyl group-containing monomer (copolymerizable monomer D) is used; and the compound has an isocyanate group, is a particularly preferable example.

Also, the compound having a functional group (ii) may further has a radical polymerizable functional group such as a (meth)acryloyl group. Thereby, an adhesive agent layer can be formed while maintaining the photocurability (crosslinkability) of the (meth)acrylic acid ester (co)polymer by the radical polymerizable functional group. More specifically, the case where the (meth)acrylic acid ester (co)polymer has a hydroxyl group; the (meth)acrylic acid ester copolymer as a copolymer of a monomer component containing, for example, the hydroxyl group-containing monomer is used; and the compound has a (meth)acryloyl group, for example, the case where the compound is 2-acryloyloxyethyl isocyanate, 2-methacryloyloxyethyl isocyanate, 1,1-(bisacryloyloxymethyl) ethyl isocyanate, or the like, is a particularly preferable example.

Thus, it is preferable to utilize the crosslinking reaction between the (meth)acrylic acid ester (co)polymers by the radical polymerizable functional group, since there is an advantage that the cohesive force after photocuring (crosslinking) is efficiently increased and the reliability is excellent even without using a polyfunctional (meth)acrylate having two or more (meth)acryloyl groups.

As another specific example of the method (1), a method using the hydrogen abstraction-type initiator as a photopolymerization initiator can be cited. The hydrogen abstraction-type initiator can be reused as a photopolymerization initiator since, even if once excited, some of the initiators that has not reacted return to the ground state. Thus, by using the hydrogen abstraction-type photoinitiator, the photocurability (crosslinkability) by the photopolymerization initiator can be maintained even after the production of the adhesive sheet.

Specific examples of the method (2) may include a method using the aforementioned macromonomers as monomer components constituting the (meth)acrylic acid ester copolymer. More specifically, a method using a graft copolymer comprising the macromonomers as branch components can be cited. By using such macromonomers, a state as if the composition (adhesive agent) is physically crosslinked by pulling the branch components each other can be maintained at room temperature.

Accordingly, the sheet condition can be maintained while being kept as uncured (uncrosslinked), so that an adhesive sheet having an adhesive agent layer containing a photoinitiator that generates radicals upon receiving light can be produced. Here, as the photopolymerization initiator, any of the aforementioned cleavage-type photoinitiator and the hydrogen abstraction-type photoinitiator may be used.

<Usage Form of Present Adhesive Sheet>

The present adhesive sheet may be used in such a manner that the present adhesive agent composition is directly coated on an adherend to form a sheet shape, and in addition, the present adhesive sheet may be used as an adhesive sheet with a release film that is molded to a single layered or multilayered sheet on the release film.

Examples of the material of the release film may include a polyester film, a polyolefin film, a polycarbonate film, a polystyrene film, an acrylic film, a triacetyl cellulose film, and a fluorine resin film. Among others, a polyester film and a polyolefin film are particularly preferred.

The thickness of the release film is not particularly limited. From the viewpoint of processability and handleability, the thickness thereof is preferably 25 to 500 μm, more preferably 38 μm or more or 250 μm or less, even more preferably 50 μm or more or 200 μm or less.

In addition, a method in which the present adhesive agent composition is directly extruded and molded, or a method in which the present adhesive agent composition is molded by injecting into a mold, without using the adherend and the release film described above, can be employed for forming the present adhesive sheet. Further, the adhesive sheet can also be formed by directly filling the present adhesive agent composition between members such as conductive members.

<Method for Suppressing Corrosion of Conductive Member Using Present Adhesive Sheet>

After the present adhesive sheet is laminated on a conductive member comprising a silver-containing metal material, for example, a conductive member formed of a metal material containing silver, a part or all of the silver in the conductive member is coated with a metal corrosion inhibitor in the present adhesive sheet at the time of irradiating with light, so that the present adhesive sheet is able to suppress the reaction between the radicals generated from the photoinitiator by the light irradiation and the silver in the conductive member. Thus, the present adhesive sheet can be used for such a method of suppressing the corrosion of the conductive member.

<Application of Present Adhesive Sheet>

The present adhesive sheet can be suitably used for being bonded to a conductive member comprising a silver-containing metal material, for example, a conductive member formed of a metal material containing silver. For example, the present adhesive sheet is suitable for bonding a conductive member containing a transparent conductive layer comprising a silver-containing metal material in an image display device, such as a personal computer, a mobile terminal (PDA), a game machine, a television (TV), a car navigation system, a touch panel, or a pen tablet, for example, in an image display device using an image display panel, such as a plasma display (PDP), a liquid crystal display (LCD), an organic EL display (OLED), an inorganic EL display, an electrophoretic display (EPD), or an interferometric modulation display (IMOD). Here, the conductive member may have an insulating protective film (passivation film).

The present adhesive sheet can be used by being bonded to a conductive member comprising, especially, a silver-containing metal material, for example, a conductive layer surface of a transparent conductive layer.

In so doing, the laminate may have a structure in which either one of the adhesive agent layer surfaces of the present adhesive sheet and the conductive layer surface of the transparent conductive layer are bonded together.

In the case where the present adhesive sheet is a double-sided adhesive sheet, the laminate may have a structure in which both the adhesive agent layer surfaces of the present adhesive sheet and the conductive layer surfaces of the transparent conductive layer are bonded together.

The transparent conductive layer may be formed with an insulating protective film (passivation film) made of an olefin polymer, an urethane polymer, an epoxy polymer, an acrylic polymer, a silicone polymer, or an inorganic glass, so as to cover the conductive layer surface of the conductive film.

In this case, the present adhesive sheet is not directly bonded to the transparent conductive layer surface (not directly in contact with the transparent conductive layer surface).

However, the metal corrosion inhibitor component in the present adhesive agent composition has high water solubility and readily moves to the transparent conductive layer when the present adhesive sheet absorbs moisture in a moist heat environment, thereby obtaining an excellent metal corrosion prevention effect. Accordingly, regardless of the presence or absence of the insulating protective film, the present adhesive sheet is able to exhibit not only the effect of preventing discoloration and deterioration of the adhesive agent layer due to metal ions in the adherend, but also an excellent metal corrosion prevention effect on the adherend.

The transparent conductive layer may have a conductive layer on at least one surface, and examples thereof may include a transparent conductive layer in which a conductive substance is provided on the surface layer of a transparent substrate by vapor deposition, sputtering, coating, or the like.

The conductive substance used for the conductive layer of the transparent conductive layer may be a silver-containing metal material, and the substrate on which the conductive substance is patterned is not particularly limited, but glass, resin film, and the like can be cited.

The transparent conductive layer typically has a conductive layer on at least one surface thereof. Also, a conductive pattern (wiring pattern) containing copper or silver as a main component is typically formed on the transparent conductive layer so as to extend around the periphery.

(Present Image Display Device Constituent Laminate)

The present adhesive sheet is suitable for constituting an image display device constituent laminate (referred to as “present image display device constituent laminate”), in which an image display device constituent member comprising a conductive member comprising a silver-containing metal material, for example, a conductive member formed of a metal material containing silver and another image display device constituent member are laminated via the present adhesive sheet.

The present image display device constituent laminate can be produced in such a manner that the two image display device-constituting members are laminated via the present adhesive sheet, and the photocurable adhesive sheet is then photocured by irradiating with light from at least one side of the image display device-constituting members.

Specific examples of the structure of the present image display device constituent laminate may include structures composed of: release film/the present adhesive sheet/touch panel; image display panel/the present adhesive sheet/touch panel; image display panel/the present adhesive sheet/touch panel/the present adhesive sheet/protection panel; polarization film/the present adhesive sheet/touch panel; and polarization film/the present adhesive sheet/touch panel/the present adhesive sheet/protection film.

The touch panel includes a structure in which a touch panel function is incorporated in a protection panel, and a structure in which a touch panel function is incorporated in an image display panel.

Accordingly, examples of the structure of the present image display device constituent laminate may include structures composed of: release film/the present adhesive sheet/protection film; release film/the present adhesive sheet/image display panel; and image display panel/the present adhesive sheet/protection film.

In addition, the structure in which the conductive layer is interposed between the present adhesive sheet and adjacent members such as a touch panel, a protection panel, an image display panel, and a polarization film in each of the above structures, can be cited. However, the present laminate is not limited to the examples of these laminates.

Examples of the touch panel may include a resistance film-type touch panel, an electrostatic capacity-type touch panel, and an electromagnetic induction-type touch panel. Among others, an electrostatic capacity-type touch panel is preferred.

The material of the protection panel may be glass or plastics such as acrylic resins, polycarbonate resins, alicyclic polyolefin resins such as cycloolefin polymers, styrene resins, polyvinyl chloride resins, phenol resins, melamine resins, and epoxy resins.

The image display panel is composed of a polarization film, another optical film such as a retardation film, a liquid crystal material, and a backlight system (usually, the adhesive surface of the present adhesive composition or the adhesive article with respect to the image display panel is an optical film). Examples of the image display panel may include an STN-type, a VA-type, and an IPS-type depending on the control method of the liquid crystal material, and any type of the image display panel may be used.

The present image display device constituent laminate can be used as a constituent member of image display devices such as a liquid crystal display, an organic EL display, an inorganic EL display, electronic paper, a plasma display, and a microelectromechanical system (MEMS) display.

### Explanation of Terms

In the case of being expressed as the term “X to Y” (X and Y are arbitrary numbers) in the present description, unless otherwise stated, the term includes the meaning of “preferably more than X” or “preferably less than Y” along with the meaning “not less than X and not more than Y”.

Further, in the case of being expressed as the term “X or more” (X is an arbitrary number) or the term “Y or less” (Y is an arbitrary number), the term also includes the intention of being “preferably more than X” or “preferably less than Y”.

In the present invention, the term “film” is intended to include “sheet”, and the term “sheet” is intended to include “film”.

### EXAMPLES

Hereinafter, the present invention will be described based on the following Examples and Comparative Examples. However, the present invention is not limited to the following Examples.

### Example 1

A resin composition 1 was produced by uniformly melt-kneading: 1 kg of a copolymer (A-1, mass average molecular weight: 150,000) in which the branch component was a macromonomer (number average molecular weight: 2,500) composed of methyl methacrylate (7 parts by mass) and isobornyl methacrylate (7 parts by mass), and the stem component was composed of lauryl acrylate (43 parts by mass), ethylhexyl acrylate (40 parts by mass), and acrylamide (3 parts by mass), as the (meth)acrylic acid ester (co)polymer (a); 100 g of pentaerythritol triacrylate (B-1) as the crosslinking agent (b); 10 g of a mixture (C-1) of 2,4,6-trimethylbenzophenone and 4-methylbenzophenone as the photoinitiator (c); and 3 g of 1,2,3-triazole (D-1, absorption coefficient: 0.3 mL/g·cm, aqueous solubility: >1,000 g/L) as the metal corrosion inhibitor (d).

The resin composition 1 was sandwiched with two release-treated polyethylene terephthalate films (“DIAFOIL MRF” with a thickness of 75 μm and “DIAFOIL MRT” with a thickness of 38 μm, both manufactured by Mitsubishi Chemical Corporation), and formed into a sheet shape at a temperature of 80° C. so as to have a thickness of 150 μm, thereby producing a transparent double-sided adhesive sheet 1.

Here, the transparent double-sided adhesive sheet 1 has a property of being cured by light irradiation.

### Example 2

A resin composition 2 was produced by uniformly melt-kneading: 1 kg of the aforementioned copolymer (A-1) as the (meth)acrylic acid ester (co)polymer (a); 100 g of the aforementioned pentaerythritol triacrylate (B-1) as the crosslinking agent (b); 10 g of 2,4,6-trimethylbenzoyl-diphenyl-phosphine oxide (C-2) as the photoinitiator (c); and 5 g of the aforementioned 1,2,3-triazole (D-1) as the metal corrosion inhibitor (d).

The resin composition 2 was formed into a sheet shape in the same manner as in Example 1, thereby producing a transparent double-sided adhesive sheet 2.

Here, the transparent double-sided adhesive sheet 2 has a property of being cured by light irradiation.

### Example 3

A resin composition 3 was produced by uniformly melt-kneading: 1 kg of the aforementioned copolymer (A-1) as the (meth)acrylic acid ester (co)polymer (a); 100 g of glycerin dimethacrylate (B-2) as the crosslinking agent (b); 10 g of the aforementioned mixture (C-1) as the photoinitiator (c); and 1 g of 1,2,4-triazole (D-2, absorption coefficient: 0.3 mL/g·cm, aqueous solubility: >1,000 g/L) as the metal corrosion inhibitor (d).

The resin composition 3 was formed into a sheet shape in the same manner as in Example 1, thereby producing a transparent double-sided adhesive sheet 3.

Here, the transparent double-sided adhesive sheet 3 has a property of being cured by light irradiation.

### Example 4

A resin composition 4 was produced by uniformly melt-kneading: 1 kg of a copolymer (A-2, mass average molecular weight: 400,000) composed of 2-ethylhexyl acrylate (65 parts by mass), methyl acrylate (32 parts by mass), and acrylamide (3 parts by mass) as the (meth)acrylic acid ester (co)polymer (a); 20 g of the aforementioned pentaerythritol triacrylate (B-1) as the crosslinking agent (b); 10 g of the aforementioned mixture (C-1) as the photoinitiator (c); and 3 g of the aforementioned 1,2,3-triazole (D-1) as the metal corrosion inhibitor (d).

The resin composition 4 was sandwiched with the two release-treated polyethylene terephthalate films (“DIAFOIL MRF” with a thickness of 75 μm and “DIAFOIL MRT” with a thickness of 38 μm); formed into a sheet shape at a temperature of 60° C. so as to have a thickness of 150 μm; and irradiated with light using a high-pressure mercury lamp through a PET film such that the integrated light amount at a wavelength of 365 nm was 800 mJ/cm², thereby producing a transparent double-sided adhesive sheet 4.

Here, the transparent double-sided adhesive sheet 4 is in a semi-cured state, that is, in a state where there is room for further photocuring, by adjusting the irradiation amount of ultraviolet rays.

### Example 5

A resin composition 5 was produced by uniformly melt-kneading: 1 kg of the aforementioned copolymer (A-1) as the (meth)acrylic acid ester (co)polymer (a); 50 g of the aforementioned pentaerythritol triacrylate (B-1) as the crosslinking agent (b); 10 g of the aforementioned mixture (C-1) as the photoinitiator (c); and 5 g of 1,2,3-benzotriazole (D-3, absorption coefficient: 0.8 mL/g·cm, aqueous solubility: 20 g/L) as the metal corrosion inhibitor (d).

The resin composition 5 was formed into a sheet shape in the same manner as in Example 1, thereby producing a transparent double-sided adhesive sheet 5.

Here, the transparent double-sided adhesive sheet 5 has a property of being cured by light irradiation.

### Comparative Example 1

A resin composition 6 was produced by uniformly melt-kneading: 1 kg of a copolymer (A-3, mass average molecular weight: 300,000) in which the branch component was a macromonomer (number average molecular weight: 2,500) composed of methyl methacrylate (15 parts by mass), and the stem component was composed of n-butyl acrylate (81 parts by mass) and acrylic acid (4 parts by mass), as the (meth)acrylic acid ester (co)polymer (a); 100 g of the aforementioned glycerin dimethacrylate (B-2) as the crosslinking agent (b); and 10 g of the aforementioned mixture (C-1) as the photoinitiator (c). The metal corrosion inhibitor (d) was not added therein.

The resin composition 6 was sandwiched with the two release-treated polyethylene terephthalate films (“DIAFOIL MRF” with a thickness of 75 μm and “DIAFOIL MRT” with a thickness of 38 μm), and formed into a sheet shape at a temperature of 80° C. so as to have a thickness of 150 μm, thereby producing a transparent double-sided adhesive sheet 6.

Here, the transparent double-sided adhesive sheet 6 has a property of being cured by light irradiation.

### Comparative Example 2

A resin composition 7 was produced by uniformly melt-kneading: 1 kg of the aforementioned copolymer (A-1) as the (meth)acrylic acid ester (co)polymer (a); 100 g of the aforementioned pentaerythritol triacrylate (B-1) as the crosslinking agent (b); and 10 g of the aforementioned mixture (C-1) as the photoinitiator (c). The metal corrosion inhibitor (d) was not added therein.

The resin composition 7 was formed into a sheet shape in the same manner as in Comparative Example 1, thereby producing a transparent double-sided adhesive sheet 7.

Here, the transparent double-sided adhesive sheet 7 has a property of being cured by light irradiation.

### Comparative Example 3

A resin composition 8 was produced by uniformly melt-kneading: 1 kg of the aforementioned copolymer (A-1) as the (meth)acrylic acid ester (co)polymer (a); 100 g of the aforementioned pentaerythritol triacrylate (B-1) as the crosslinking agent (b); and 10 g of the aforementioned 2,4,6-trimethylbenzoyl-diphenyl-phosphine oxide (C-2) as the photoinitiator (c). The metal corrosion inhibitor (d) was not added therein.

The resin composition 8 was formed into a sheet shape in the same manner as in Comparative Example 1, thereby producing a transparent double-sided adhesive sheet 8.

Here, the transparent double-sided adhesive sheet 8 has a property of being cured by light irradiation.

### Comparative Example 4

A resin composition 9 was produced by uniformly melt-kneading: 1 kg of the aforementioned copolymer (A-3) as the (meth)acrylic acid ester (co)polymer (a); 100 g of the aforementioned glycerin dimethacrylate (B-2) as the crosslinking agent (b); 10 g of the aforementioned mixture (C-1) as the photoinitiator (c); and 3 g of the aforementioned 1,2,3-triazole (D-1) as the metal corrosion inhibitor (d).

The resin composition 9 was formed into a sheet shape in the same manner as in Comparative Example 1, thereby producing a transparent double-sided adhesive sheet 9.

Here, the transparent double-sided adhesive sheet 9 has a property of being cured by light irradiation.

### Comparative Example 5

A resin composition 10 was produced by uniformly melt-kneading: 1 kg of the aforementioned copolymer (A-1) as the (meth)acrylic acid ester (co)polymer (a); 100 g of the aforementioned glycerin dimethacrylate (B-2) as the crosslinking agent (b); 10 g of the aforementioned mixture (C-1) as the photoinitiator (c); and 5 g of 2,5-dimercapto-1,3,4-thiadiazole (D-4, absorption coefficient: 90 mL/g·cm, aqueous solubility: 20 g/L) as the metal corrosion inhibitor (d).

The resin composition 10 was formed into a sheet shape in the same manner as in Comparative Example 1, thereby producing a transparent double-sided adhesive sheet 10.

Here, the transparent double-sided adhesive sheet 10 has a property of being cured by light irradiation.

### Comparative Example 6

A resin composition 11 was produced by uniformly melt-kneading: 1 kg of the aforementioned copolymer (A-1) as the (meth)acrylic acid ester (co)polymer (a); 100 g of the aforementioned glycerin dimethacrylate (B-2) as the crosslinking agent (b); 10 g of the aforementioned mixture (C-1) as the photoinitiator (c); and 5 g of mercaptobenzothiazole (D-5, absorption coefficient: 65 mL/g·cm, aqueous solubility: 0.3 g/L) as the metal corrosion inhibitor (d).

The resin composition 11 was formed into a sheet shape in the same manner as in Comparative Example 1, thereby producing a transparent double-sided adhesive sheet 11.

Here, the transparent double-sided adhesive sheet 11 has a property of being cured by light irradiation.

The photocurable transparent double-sided adhesive sheets 1 to 11 were subjected to various evaluations described below. The results are shown in Table 1.

<Various Evaluations>

(1) Step Absorbability

Each of the transparent double-sided adhesive sheets 1 to 11 with the release films laminated was cut into a size of 50×80 mm using a Thomson punching machine. The release film on one side was peeled off, and the exposed adhesive surface was press-laminated (at a temperature of 25° C. and a press pressure of 0.04 MPa) to the printed surface of a soda lime glass (82 mm×53 mm×0.5 mm thick) formed by applying printing with a thickness of 40 μm to the peripheral portion of 5 mm, using a vacuum press machine such that the four sides of the adhesive sheet were laminated on the printing step. Next, the remaining release film was peeled off, and press-laminated to a soda lime glass (82 mm×53 mm×0.5 mm thick) having no printing step. Then, the press-laminated article was subjected to an autoclave treatment (for 20 minutes at 60° C. and a gauge pressure of 0.2 MPa) for finish-adhesion, thereby producing a laminate having a structure of glass with step/adhesive sheet/glass.

The laminate thus produced was visually observed. The laminate in which the adhesive sheet did not follow in the vicinity of the printing step and air bubbles remained was determined as “X (poor)”, and the laminate having no air bubbles and having good appearance was determined as “◯ (good)”.

(2) Foaming Resistance Reliability

Among the laminates having a structure of glass with step/adhesive sheet/glass that were produced in the step absorbability evaluation, the sample that was smoothly bonded without air bubbles was cured by irradiating with light using a high-pressure mercury lamp from the glass side such that the integrated light amount at a wavelength of 365 nm was 2,000 mJ/cm². The sample was left to stand at room temperature for 12 hours, then stored for 500 hours in an environment of 65° C. and 90% RH, and thereafter the appearance thereof was visually evaluated.

The sample with deformation, foaming, or peeling occurred on the adhesive sheet after the environmental test was determined as “X (poor)”, and the sample with no deformation, foaming, or peeling occurred on the adhesive sheet was determined as “◯ (good)”.

(3) Silver Corrosion Resistance

As a conductive member comprising a silver-containing metal, a silver nanowire film (Activegrid Film, manufactured by C3 nano Inc., substrate: polyethylene terephthalate (thickness: 50 μm), surface resistance value: 50Ω/□, with an overcoat layer, total light transmittance: >91%, haze: ≤0.9%, b*: ≤1.3) was prepared.

The silver nanowire film was cut into a size of 45 mm length×80 mm width, and a silver paste (Dotite D-550, manufactured by Fujikura Kasei Co., Ltd.) is coated thereon in a width of about 3 to 5 mm in the vertical direction such that the interval between the electrodes was 50 mm. Then, the resulting sheet was dried, and was cut in the horizontal direction such that the vertical width of the sheet was 9 mm. The five silver nanowire films, each having a size of 9 mm×80 mm, with silver paste electrodes were placed in parallel on a soda lime glass.

The release film on one side of each of the transparent double-sided adhesive sheets 1 to 11 that were cut into a width of 50 mm was peeled off, and was bonded on the soda lime glass with a roll such that the adhesive sheet was positioned between the electrodes. Thereafter, the resulting article was subjected to an autoclave treatment (for 20 minutes at 60° C. and a gauge pressure of 0.2 MPa) for finish-adhesion, and was cured by irradiating with light using a high-pressure mercury lamp from the side of the adhesive sheet with release film such that the integrated light amount at a wavelength of 365 nm was 2,000 mJ/cm², thereby obtaining a sample.

The sample was subjected to environmental tests under the following environments (1) and (2) to confirm an increase in resistance value between the electrodes;

(1) hygrothermal environment at 65° C. and 90% RH for 300 hours (“Ω UP % (Hygrothermal) in the table); and

(2) UV irradiating environment using a UV fade meter (500 mW/m², BPT: 63° C.) for 300 hours (“Ω UP % (UV)” in the table).

As an over-all evaluation of the environmental tests, the sample in which the increase in resistance value was more than 10% in both the hygrothermal environment and the UV irradiating environment, or the sample that was disconnected was determined as “X (poor)”; the sample in which the increase in resistance value was 10% or less in either one of the hygrothermal environment and the UV irradiating environment was determined as “◯ (good)”; and the sample in which the increase in resistance value was 1% or less in both the hygrothermal environment and the UV irradiating environment was determined as “⊚ (very good)”.

TABLE 1

| | | | | | | | | | Comparative |
|---|---|---|---|---|---|---|---|---|---|
| | | | | Example 1 | Example 2 | Example 3 | Example 4 | Example 5 | Example 1 |
| Composition | (Meth)Acrylic | A-1 | | 100 | 100 | 100 | | 100 | |
| | (Co)Polymer | A-2 | | | | | 100 | | |
| | | A-3 | | | | | | | 100 |
| | Crosslinking | B-1 | | 10 | 10 | | 2 | 5 | |
| | Agent | B-2 | | | | 10 | | | 10 |
| | Photoinitiator | C-1 | | 1 | | 1 | 1 | 1 | 1 |
| | | C-2 | | | 0.8 | | | | |
| | Metal | D-1 | | 0.3 | 0.5 | | 0.3 | | — |
| | Corrosion | D-2 | | | | 0.2 | | | |
| | Inhibitor | D-3 | | | | | | 0.5 | |
| | | D-4 | | | | | | | |
| | | D-5 | | | | | | | |
| Physical | Before | Step Absorbability | | ◯ | ◯ | ◯ | ◯ | ◯ | ◯ |
| Property | Post UV | | | | | | | | |
| | After | Foaming | 85° C. | ◯ | ◯ | ◯ | ◯ | ◯ | ◯ |
| | Post UV | Resistance | | | | | | | |
| | | Reliability | | | | | | | |
| | | Silver | Ω UP % | 3% | <1% | 5% | 3% | 6% | 38% |
| | | Corrosion | (Hygro | | | | | | |
| | | Resistance | thermal) | | | | | | |
| | | | Ω UP % | 4% | <1% | 8% | 3% | 8% | Disconnected |
| | | | (UV) | | | | | | |
| | | | Over-All | ◯ | ⊚ | ◯ | ◯ | ◯ | X |
| | | | Evaluation | | | | | | |

| | | | | Comparative | Comparative | Comparative | Comparative | Comparative |
|---|---|---|---|---|---|---|---|---|
| | | | | Example 2 | Example 3 | Example 4 | Example 5 | Example 6 |
| Composition | (Meth)Acrylic | A-1 | | 100 | 100 | | 100 | 100 |
| | (Co)Polymer | A-2 | | | | | | |
| | | A-3 | | | | 100 | | |
| | Crosslinking | B-1 | | 10 | 10 | | 10 | 10 |
| | Agent | B-2 | | | | 10 | | |
| | Photoinitiator | C-1 | | 1 | | 1 | 1 | 1 |
| | | C-2 | | | 0.8 | | | |
| | Metal | D-1 | | — | — | 0.3 | | |
| | Corrosion | D-2 | | | | | | |
| | Inhibitor | D-3 | | | | | | |
| | | D-4 | | | | | 0.5 | |
| | | D-5 | | | | | | 0.5 |
| Physical | Before | Step Absorbability | | ◯ | ◯ | ◯ | ◯ | ◯ |
| Property | Post UV | | | | | | | |
| | After | Foaming | 85° C. | ◯ | ◯ | ◯ | X | X |
| | Post UV | Resistance | | | | | | |
| | | Reliability | | | | | | |
| | | Silver | Ω UP % | 24% | 38% | 11% | — | — |
| | | Corrosion | (Hygro | | | | | |
| | | Resistance | thermal) | | | | | |
| | | | Ω UP % | Disconnected | Disconnected | 17% | | |
| | | | (UV) | | | | | |
| | | | Over-All | X | X | X | | |
| | | | Evaluation | | | | | |

From the results of Examples, Comparative Examples, and the tests that have been performed by the present inventors, it is found that, when the photocurable adhesive sheet containing a (meth)acrylic acid ester (co)polymer containing no carboxyl group-containing monomers, a photoinitiator that generated radicals upon receiving light, a metal corrosion inhibitor having an absorption coefficient at 365 nm of 20 mL/g·cm or less, particularly a triazole-based compound was used, and when the adhesive sheet was cured by irradiating with light after laminating the adhesive sheet on a conductive member comprising a silver-containing metal material, a protective film was formed on the silver in the conductive member by the metal corrosion inhibitor in the adhesive sheet at the time of irradiating with light, so that the reaction between the radicals generated from the photoinitiator by the light irradiation and the silver in the conductive member could be suppressed, and corrosion of the conductive member could be suppressed.

In addition, the transparent double-sided adhesive sheet in each of Examples 1 to 5 was excellent in silver corrosion resistance while maintaining high step absorbability and high foaming resistance reliability after UV curing, which were characteristics of the photocurable adhesive sheet, and was able to suppress the increase in resistance value in the environmental tests even after being bonded to the silver nanowire that had a large surface area and was readily corroded as compared to silver wiring and silver mesh. Among them, the transparent double-sided adhesive sheet in Example 2 using a cleavage-type photoinitiator and containing a metal corrosion inhibitor exhibited extremely excellent silver corrosion resistance.

In contrast, the transparent double-sided adhesive sheet in Comparative Example 1 was inferior in silver corrosion resistance, since an acid was contained in the (meth)acrylic acid ester (co)polymer and no metal corrosion inhibitor was used.

Also, the transparent double-sided adhesive sheet in each of Comparative Examples 2 and 3 was inferior in silver corrosion resistance, since no metal corrosion inhibitor was used although an acid was not contained in the (meth) acrylic acid ester (co) polymer.

Further, in Comparative Example 4, the silver corrosion could not be completely suppressed since an acid was contained in the (meth)acrylic acid ester (co)polymer although a metal corrosion inhibitor was used.

The transparent double-sided adhesive sheet in each of Comparative Examples 5 and 6 was inferior in foaming resistance reliability after post UV curing, since the metal corrosion inhibitor having a large absorption coefficient at a wavelength of 365 nm was used and the metal corrosion inhibitor inhibited photocuring of the adhesive sheet.

1. A photocurable adhesive sheet, comprising an adhesive agent layer containing a (meth)acrylic acid ester (co)polymer, a photoinitiator which generates radicals upon receiving light, and a metal corrosion inhibitor having an absorption coefficient at 365 nm of 20 mL/g·cm or less,
wherein the (meth)acrylic acid ester (co)polymer is a (co)polymer containing no carboxyl group-containing monomers.

2. The photocurable adhesive sheet according to claim 1, wherein the photoinitiator is a cleavage-type photoinitiator.

3. The photocurable adhesive sheet according to claim 1, wherein an aqueous solubility of the metal corrosion inhibitor at 25° C. is 20 g/L or more.

4. The photocurable adhesive sheet according to claim 1, wherein the metal corrosion inhibitor is a triazole-based compound.

5. The photocurable adhesive sheet according to claim 1, comprising the metal corrosion inhibitor at a ratio of 10 to 200 parts by mass relative to 100 parts by mass of the photoinitiator.

6. The photocurable adhesive sheet according to claim 1, wherein the (meth)acrylic acid ester (co)polymer has a chemical bond by any combination of functional groups selected from an amide group and a carboxyl group, and a hydroxyl group and an isocyanate group, or is a graft copolymer comprising a macromonomer as a branch component.

7. A conductive member provided with a photocurable adhesive sheet, comprising the photocurable adhesive sheet according to claim 1 and a silver-containing metal material.

8. A photocurable adhesive sheet for a conductive member, which is the photocurable adhesive sheet according to claim 1,
wherein the photocurable adhesive sheet for a conductive member is used for being bonded to a conductive member comprising a silver-containing metal material.

9. The photocurable adhesive sheet for a conductive member according to claim 8, wherein the conductive member has a transparent conductive layer comprising a silver-containing metal material.

10. The photocurable adhesive sheet for a conductive member according to claim 8, wherein the conductive member has an insulating protective film (passivation film).

11. A method for producing an image display device constituent laminate, comprising an image display device constituent member which comprises a conductive member comprising a silver-containing metal material and the other image display device constituent member,
wherein the two image display device constituent members are laminated via the photocurable adhesive sheet according to claim 1, and the photocurable adhesive sheet is then photocured by irradiating with light from at least one of the image display device constituent member sides.

12. A method for suppressing corrosion of a conductive member, which is a method for suppressing corrosion of the conductive member in which a photocurable adhesive sheet is laminated on a conductive member comprising a silver-containing metal material and the adhesive sheet is then cured by irradiating with light,
wherein the method comprises laminating the photocurable adhesive sheet according to claim 1 on the conductive member, and coating a part or all of silver contained in the conductive member with a metal corrosion inhibitor in the adhesive sheet at the time of irradiating with light, to prevent reaction between radicals generated from a photoinitiator by the light irradiation and the silver in the conductive member.
